(19) United States
(12) Patent Application Publication
(10) Pub. No.: US 2002/0179521 A1
(43) Pub. Date: Dec. 5, 2002

(54) Expansion resistant filter cartridge

(76) Inventor: C. Thomas Paul, Madison, CT (US)

Correspondence Address: Basam E. Nabulsi, CUMMINGS & LOCKWOOD, P.O. Box 1960, New Haven, CT, 06509-1960, US

(21) Appl. No.: 10/163,197

(22) Filed: Jun. 5, 2002

Related U.S. Application Data
(63) Continuation-in-part of application No. 09/874,134, filed on Jun. 5, 2001.
(60) Provisional application No. 60/209,456, filed on Jun. 5, 2000.

(51) Int. Cl. B01D 27/06

(52) U.S. Cl. 210/457; 210/485; 210/489; 210/493.1

(57) ABSTRACT

Expansion resistant filter cartridge assemblies are provided that facilitate filtering of strong solvent solutions. The filter cartridge assemblies generally include a cylindrical filter element defining an outer periphery, an inner periphery and opposed end surfaces, a perforated cage operatively associated with the outer periphery of the filter element, a perforated core operatively associated with the inner periphery of the filter element and having opposed ends and a predetermined length, and an end cap operatively associated with each of the opposed end surfaces of the filter element and bonded to each end of the core. The perforated cage generally includes an expansion region of about 2.5% to about 4% of the total length of the filter cartridge, e.g., a region of axial discontinuity or a plurality of angular struts, to accommodate swelling and/or dimensional expansion of the cage without adversely affecting the integrity of the filter cartridge assembly. Alternatively, an expandable net material may be provided to accommodate expansion/swelling thereof. The core of the filter cartridge assembly is advantageously fabricated from material(s) that resist swelling/expansion when exposed to strong solvent solutions, e.g., glass filled polypropylene, a fluorinated aliphatic hydrocarbon, a filled polyolefin polymer and/or a polymer that includes a functional filler, e.g., glass fiber, a mineral-based filler, talc or the like.

### CROSS-REFERENCE TO RELATED APPLICATION

The present application claims the benefit of a co-pending patent application entitled “Expansion Resistant Filter Cartridge” that was filed by applicant on Jun. 5, 2001 and assigned Ser. No. 09/874,134, which claimed the benefit of a prior provisional patent application having the same title that was filed on Jun. 5, 2000 and assigned Serial No. 60/209,456. The entire contents of both applications are hereby incorporated by reference.

### BACKGROUND OF THE DISCLOSURE

1. Technical Field

The present disclosure relates to fluid filtration devices and, more particularly, to filter cartridge designs that resist axial expansion during use, e.g., when exposed to strong solvent solutions.

2. Background of Related Art

Pleated membrane filter cartridges are well known in the art and typically include a pleated filter element having a plurality of longitudinal pleats arranged in a cylindrical configuration, a perforated cage disposed about the outer periphery of the filter element for admitting fluid into the cartridge, a perforated core coaxially disposed within the filter element, and end caps disposed at each end of the filter element to prevent fluid from passing through the end surfaces of the filter element.

The core generally serves as an inner hollow tube on which the pleated filter element may be supported, conferring strength upon the cartridge assembly and generally determining the final assembly length of the filter cartridge. The core further generally defines the outlet port of the cartridge and filtered fluid generally passes to the outlet of the filter housing through perforations defined therein.

Typically, the core and cage of a pleated filter cartridge are constructed from a polypropylene material based, at least in part, on the fact that polypropylene is relatively inexpensive, easily moldable, easy to bond to ancillary components (e.g., end caps), and resistant to many fluids, including most solvents. However, polypropylene has a tendency to react with strong solvent solutions, such as, methylene chloride, benzene, heptane, toluene, tri-chloroethylene and xylene, in such a manner as to cause a polypropylene cartridge core to swell and/or undergo dimensional expansion. Such swelling/dimensional expansion can adversely affect the integrity of the cartridge. For example, it has been determined through testing that the length of a conventional filter cartridge having a polypropylene core will increase about three percent (3%) when soaked in methylene chloride at room temperature for an extended period of time.

The filtering of strong solvent solutions, e.g., solutions that include methylene chloride, benzene, heptane, toluene, tri-chloroethylene and/or xylene, is of particular importance and necessity in many manufacturing processes. For example, the filtering of methylene chloride is generally necessary in the manufacture of high quality polycarbonate pellets for use in the manufacture of compact discs. Additional applications that involve filtering of strong solvent solutions are found in numerous industries.

It would be beneficial, therefore, to provide an inexpensive filter cartridge assembly that resists expansion and ensures reliable operation when exposed to strong solvent solutions.

### SUMMARY OF THE DISCLOSURE

According to the present disclosure, expansion resistant filter cartridge assemblies are provided that facilitate filtering of strong solvent solutions. The disclosed filter cartridge assemblies generally include a cylindrical filter element defining an outer periphery, an inner periphery and opposed end surfaces, a perforated cage operatively associated with the outer periphery of the filter element, a perforated core operatively associated with the inner periphery of the filter element and having opposed ends and a predetermined length, and an end cap operatively associated with each of the opposed end surfaces of the filter element and bonded to each end of the core. Preferably, the end caps are either chemically or physically bonded to the core, so that the core functions as the back bone of the cartridge.

In a preferred embodiment of the present disclosure, the perforated cage is horizontally separated into a plurality of axially spaced apart cage portions, e.g., two cage portions, to permit swelling and/or dimensional expansion of the cage without adversely affecting the integrity of the filter cartridge assembly. Indeed, perforated cages according to the present disclosure that include at least one region of axial discontinuity accommodate elongation/expansion of each of the discontinuous cage portions without a resultant disruptive force being exerted on the overall filter cartridge assembly.

Alternatively, cages according to the present disclosure may be fabricated from an expandable net material to accommodate expansion/swelling thereof. A further alternative cage contemplated according to the present disclosure includes a unitary cage having an expandable region formed therein, e.g., a netting region or the like. Cage constructions as disclosed herein advantageously allow the cartridge components to swell and/or expand in ways that do not exert deleterious axial forces on the cartridge end caps or other aspects of the filter cartridge assembly when exposed to a strong solvent solution.

To further ensure optimal filter cartridge performance according to the present disclosure, it is contemplated that the core may be advantageously fabricated from material(s) that resist swelling/expansion when exposed to strong solvent solutions, e.g., methylene chloride, benzene, heptane, toluene, tri-chloroethylene and/or xylene. In a first preferred embodiment of the present disclosure, the core is fabricated from glass filled polypropylene (e.g., 40% fiberglass reinforced polypropylene), or from any fluorinated aliphatic hydrocarbon, such as, for example, MFA, PFA, PTFE, Kynar® or Halar® products.

In a further preferred embodiment of the present disclosure, the core of the disclosed filter cartridge assembly is fabricated from a glass filled polyolefin, e.g., a glass filled high density polyethylene, a glass filled high density polypropylene, or a glass filled high molecular weight polyethylene. The glass filled polyolefin advantageously exhibits limited expansion and/or structural deformation when exposed to strong solvents, e.g., methylene chloride, benzene, heptane, toluene, tri-chloroethylene and/or xylene. Preferred glass filled polyolefins utilized in fabricating the core of filter cartridge assemblies according to the present disclosure are generally available from commercial sources and may be fabricated into the desired core geometry using conventional polymer processing equipment and techniques. In exemplary embodiments of the foregoing glass filled polyolefin cores, the glass filler comprises about 10% to about 40% of the core material by weight.

According to further preferred embodiments of the present disclosure, the core of the disclosed filter cartridge assembly is fabricated from a polymer that includes a functional filler in an amount effective to limit the axial expansion of the core to an acceptable level when exposed to a strong solvent, e.g., methylene chloride, benzene, heptane, toluene, tri-chloroethylene and/or xylene. Exemplary functional fillers according to the present disclosure include glass fiber and/or mineral-based fillers, and particularly include fillers such as calcium carbonate, talc, carbon fiber and/or mica. According to the present disclosure, the addition of an effective amount of a functional filler advantageously transforms a polymer that would exhibit unacceptable axial expansion characteristics when exposed to a strong solvent into a polymeric material exhibiting advantageous axial expansion characteristics when used to fabricate a core as part of a filter cartridge assembly. The functionally filled polymeric materials thus exhibit limited expansion and/or structural deformation when exposed to strong solvents, e.g., methylene chloride, benzene, heptane, toluene, tri-chloroethylene and/or xylene. Preferred functional fillers and polymers for use in fabricating the disclosed cores according to the present disclosure are generally available from commercial sources and may be fabricated into the desired core geometry using conventional polymer processing equipment and techniques.

According to preferred embodiments of the present disclosure, the level of axial expansion exhibited by cores fabricated from the advantageous polymeric materials disclosed herein is generally less than 1.5% when exposed to a strong solvent, e.g., methylene chloride, benzene, heptane, toluene, tri-chloroethylene and/or xylene, for a period of seven days.

In accordance with a preferred embodiment of the present disclosure, the filter element is a pleated membrane filter element having a plurality of longitudinally extending pleats. The filter element generally includes at least one media layer, an upstream support material and a downstream support material. Depending upon the degree of filter surface area desired for a particular filtration application, the pleats of the filter element may be configured as radial pleats, w-pleats or spiral pleats, each of which is well known in the art. It is further contemplated according to the present disclosure that expansion of the filter cartridge assembly can also be limited, at least in part, by fabricating the filter media and support materials associated therewith from plastic materials such as fluorinated aliphatic hydrocarbon materials.

In sum, the present disclosure is generally directed to an inexpensive expansion resistant filter cartridge assembly having a core that exhibits an advantageously limited level of axial expansion when exposed to a strong solvent, e.g., methylene chloride, benzene, heptane, toluene, tri-chloroethylene and/or xylene. The core may be advantageously used in conjunction with a “split” or “net” cage. These and other unique features of the filter cartridge assemblies of the present disclosure will become more readily apparent from the detailed description, the associated figures, and the claims which follow.

### BRIEF DESCRIPTION OF THE FIGURES

So that those having ordinary skill in the art to which the subject matter of the present disclosure appertains will more readily understand how to construct and use the disclosed filter cartridge assemblies, reference may be had to the drawings wherein:

FIG. 1 is a perspective view of an exemplary cartridge housing for use with filter cartridge assemblies according to the present disclosure;

FIG. 2 is an exploded perspective view of the cartridge housing of FIG. 1, with an exemplary filter cartridge according to the present disclosure depicted therewithin;

FIG. 3 is a further exploded perspective view directed to the exemplary filter cartridge depicted in FIG. 2;

FIG. 4 is a partial cut-away perspective view of a core according to an embodiment of the present disclosure;

FIG. 5 is a partial cut-away perspective view of an alternative core according to an embodiment of the present disclosure;

FIG. 6 is a partial cut-away perspective view of a further alternative core according to an embodiment of the present disclosure;

FIG. 7 is a side view of a prior art filter cartridge assembly in which the filter cartridge has separated from the end cap due to swelling/expansion of the filter cartridge assembly;

FIG. 8 is a side view of an exemplary embodiment of a filter cartridge assembly according to the present disclosure prior to use in filtering a solvent system;

FIG. 9 is a partial cut-away side view of the filter cartridge assembly of FIG. 8 subsequent to use in filtering a solvent system;

FIG. 10 is side view of an alternative exemplary embodiment of a filter cartridge assembly according to the present disclosure prior to use in filtering a solvent system; and

FIG. 11 is a partial cut-away side view of the filter cartridge assembly of FIG. 10 subsequent to use in filtering a solvent system.

### DETAILED DESCRIPTION OF PREFERRED EMBODIMENT(S)

According to the present disclosure, expansion resistant filter cartridge assemblies are provided that facilitate filtering of strong solvent solutions. A host of industrial applications entail the filtering of strong solvent solutions and the presently disclosed filter cartridge assemblies provide an enhanced, cost effective, efficacious filtering system for use in such applications.

Before describing exemplary filter cartridge assemblies according to the present disclosure with reference to the attached figures, a brief description of salient features and components of the disclosed filter cartridge assemblies is provided herein. The disclosed filter cartridge assemblies generally include a cylindrical filter element defining an outer periphery, an inner periphery and opposed end surfaces, a perforated cage operatively associated with the outer periphery of the filter element, a perforated core operatively associated with the inner periphery of the filter element and having opposed ends and a predetermined length, and an end cap operatively associated with each of the opposed end surfaces of the filter element and bonded to each end of the core. Preferably, the end caps are either chemically or physically bonded to the core, so that the core functions as the backbone of the cartridge assembly.

Preferably, the perforated cage is horizontally separated into a plurality of axially spaced apart cage portions, e.g., two cage portions, to permit swelling and/or dimensional expansion of the cage without adversely affecting the integrity of the filter cartridge assembly. Indeed, perforated cages according to the present disclosure, which include at least one region of axial discontinuity, accommodate elongation/expansion of each of the discontinuous cage portions without a resultant disruptive force being exerted on the overall filter cartridge assembly.

Alternatively, cages according to the present disclosure may be fabricated from an expandable net material to accommodate expansion/swelling thereof. A further alternative cage contemplated according to the present disclosure includes a unitary cage having an expandable region formed therein, e.g., a netting region or the like. Cage constructions disclosed herein advantageously permit the cartridge components to swell and/or expand in ways that do not exert deleterious axial forces on the cartridge end caps or other aspects of the filter cartridge assembly when exposed to a strong solvent solution.

To further ensure optimal filter cartridge performance according to the present disclosure, it is contemplated that the core may be advantageously fabricated from material(s) that resist swelling/expansion when exposed to strong solvent solutions, e.g., methylene chloride, benzene, heptane, toluene, tri-chloroethylene and/or xylene. In a preferred embodiment of the present disclosure, the core is constructed from glass filled polypropylene (e.g., 40% fiberglass reinforced polypropylene). It is further envisioned that the core may be advantageously constructed from a fluorinated aliphatic hydrocarbon, such as, for example, MFA, PFA, PTFE, Kynar® or Halar® products.

In a further preferred embodiment of the present disclosure, the core of the disclosed filter cartridge assembly is fabricated from a glass filled polyolefin. Preferred glass filled polyolefins according to the present disclosure include glass filled high density polyethylene, glass filled polypropylene, and glass filled high molecular weight polyethylene. A core fabricated from a glass filled polyolefin according to the present disclosure advantageously exhibits limited expansion and/or structural deformation when exposed to strong solvents, e.g., methylene chloride, benzene, heptane, toluene, tri-chloroethylene and/or xylene. Preferred glass filled polyolefins utilized in fabricating the core of filter cartridge assemblies according to the present disclosure are generally available from commercial sources and may be fabricated into the desired core geometry using conventional polymer processing equipment and techniques.

According to further preferred embodiments of the present disclosure, the core of the disclosed filter cartridge assembly is fabricated from a polymer that includes a functional filler in an amount effective to limit the axial expansion the core to an acceptable level when exposed to a strong solvent, e.g., methylene chloride, benzene, heptane, toluene, tri-chloroethylene and/or xylene. Exemplary functional fillers according to the present disclosure include glass fiber and mineral-based fillers, and particularly include fillers such as calcium carbonate, talc, carbon fiber and/or talc. According to the present disclosure, the addition of an effective amount of a functional filler advantageously transforms a polymer that would exhibit unacceptable axial expansion characteristics when exposed to a strong solvent into a polymeric material exhibiting advantageous axial expansion characteristics when used to fabricate a core as part of a filter cartridge assembly. For example, a high density polyethylene may be glass filled at a level of about 10% to 40% by weight to achieve the desired axial expansion characteristics in a core exposed to a strong solvent according to the present disclosure. Similarly, a high density polyethylene may be talc-filled at a level of about 10% to 40% by weight to provide a core exhibiting an advantageously limited level of axial expansion when exposed to a strong solvent. A high density polyethylene may be filled by carbon fibers at a level of about 25% to 35% by weight to provide a core exhibiting an advantageously limited level of axial expansion when exposed to a strong solvent. A high density polyethylene may also be mica-filled at a level of about 10% to 50% by weight to provide a core exhibiting an advantageously limited level of axial expansion when exposed to a strong solvent. Comparable filler levels for the above-identified filler materials are contemplated for alternative polyolefin materials according to the present disclosure. Additional exemplary filled polyolefins exhibiting advantageous axial deformation properties according to the present disclosure are described herein below.

The functionally filled polymeric materials thus exhibit limited expansion and/or structural deformation when exposed to strong solvents, e.g., methylene chloride, benzene, heptane, toluene, tri-chloroethylene and/or xylene. Preferred functional fillers and polymers for use in fabricating the disclosed cores according to the present disclosure are generally available from commercial sources and may be fabricated into the desired core geometry using conventional polymer processing equipment and techniques.

According to preferred embodiments of the present disclosure, the level of axial expansion exhibited by cores fabricated from the advantageous polymeric materials disclosed herein is generally less than 1.5% when exposed to a strong solvent, e.g., methylene chloride, benzene, heptane, toluene, tri-chloroethylene and/or xylene, for a period of seven days.

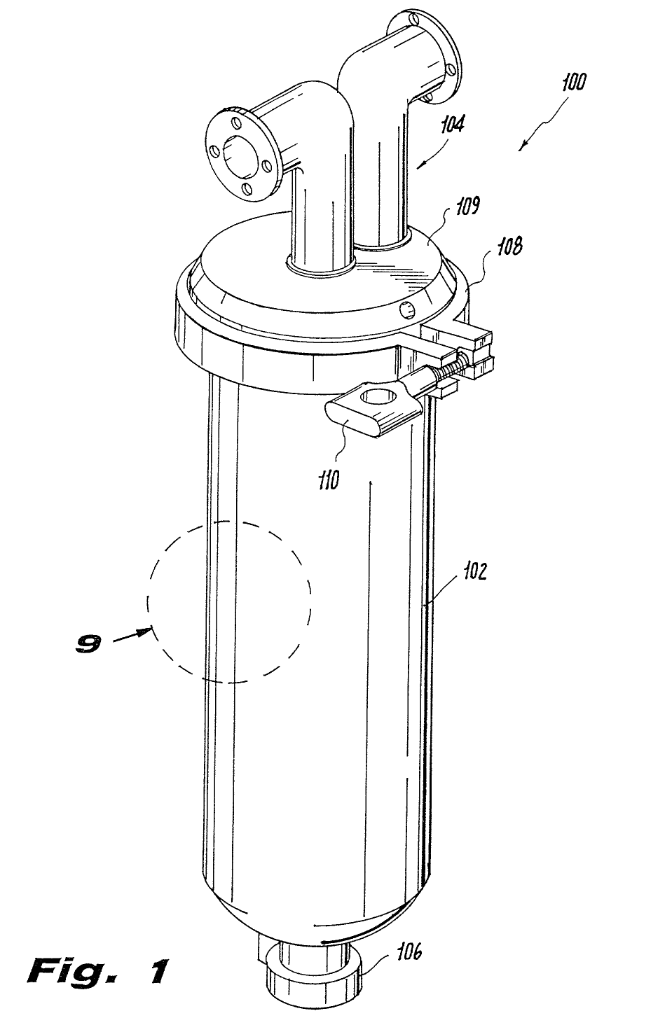

With reference to FIG. 1, an exemplary filter cartridge housing 100 is depicted that includes a cylindrical housing body 102, a T-head 104 and a lower port 106. Cap 109 is detachably secured to housing body 102 by expandable bracket 108. Threaded member 110 may be tightened to fix bracket 108 onto cap 109, thereby securing cap 109 to housing body 102. Conversely, the interior of cartridge housing 100 may be accessed by untightening threaded member 110, thereby releasing bracket 108 and permitting removal of cap 109 from housing body 108. The operation and use of filter cartridge housings of the type depicted in FIG. 1 within conventional filtering applications are well known, and will not be described herein.

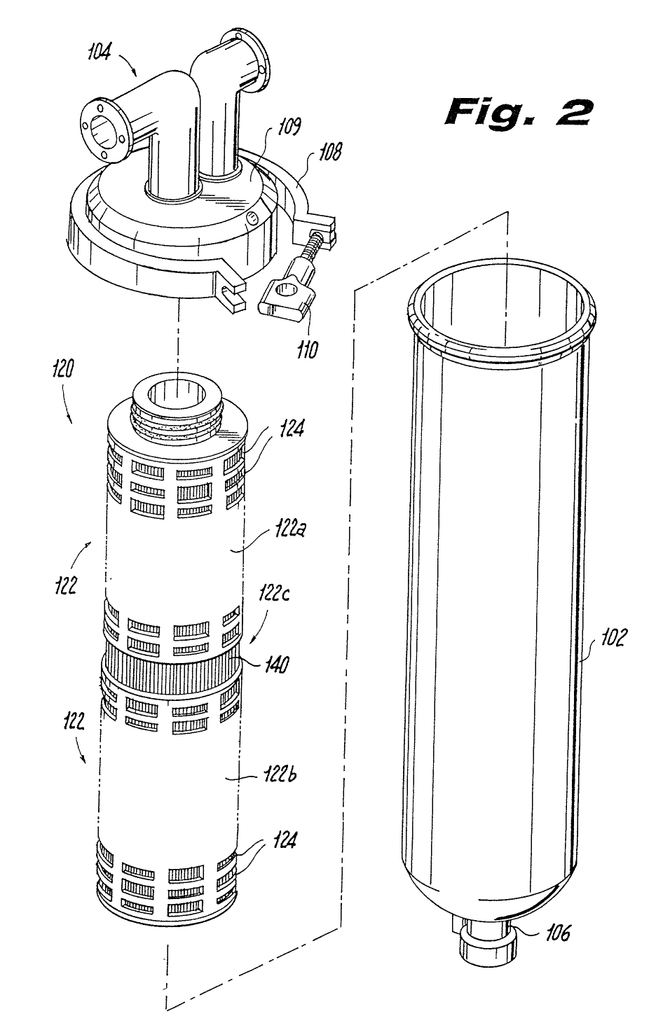

Turning to FIGS. 2 and 3, the components positioned within filter cartridge housing 100 are depicted. Filter cartridge 120 includes a perforated cage 122 that is defined by first and second cage portions 122a, 122b that are separated by discontinuous region 122c. Perforations 124 are generally rectangular in shape and relatively evenly spaced across the surface of cage 122, although other perforation shapes, spacings and dimensions are contemplated, as are known in the art. An end cap 126 and adapter 128 are deployed at a first end of cage 122, and a second end cap 130 is deployed at an opposite end of cage 122. End caps 126, 130 are typically chemically or physically bonded or otherwise fixedly joined to core 150, as is known in the art. Similarly, adapter 128 is typically bonded or otherwise fixedly joined to end cap 126. Additional components may be employed with end cap 130, as are known in the art, e.g., a spear, closed cap, or the like.

When assembled within cartridge housing 100, cage portion 122a abuts and is generally joined to end cap 126, while cage portion 122b abuts and is generally joined to end cap 128, thereby defining two subassemblies within cartridge housing 100. The two subassemblies are spaced apart by a discontinuous region 122c of predetermined dimension, as described in greater detail hereinbelow. The outer diameter of cage 122 and the inner diameter of cartridge housing body 102 define a flow passage to facilitate flow of fluid to be filtered within filter cartridge assembly 100, as is known in the art.

With further reference to FIGS. 2 and 3, an elongated filter element 140 is deployed within cage 122. The exemplary filter element 140 depicted in FIGS. 2 and 3 is a pleated membrane filter element defining a central cylindrical opening 142 and a plurality of longitudinally extending pleats. Filter element 140 typically has at one least media layer, an upstream support material and a downstream support material. Depending upon the degree of filter surface area desired for a particular filtration application, the pleats of filter element 140 may be configured as radial pleats, w-pleats or spiral pleats, each of which is well known in the art.

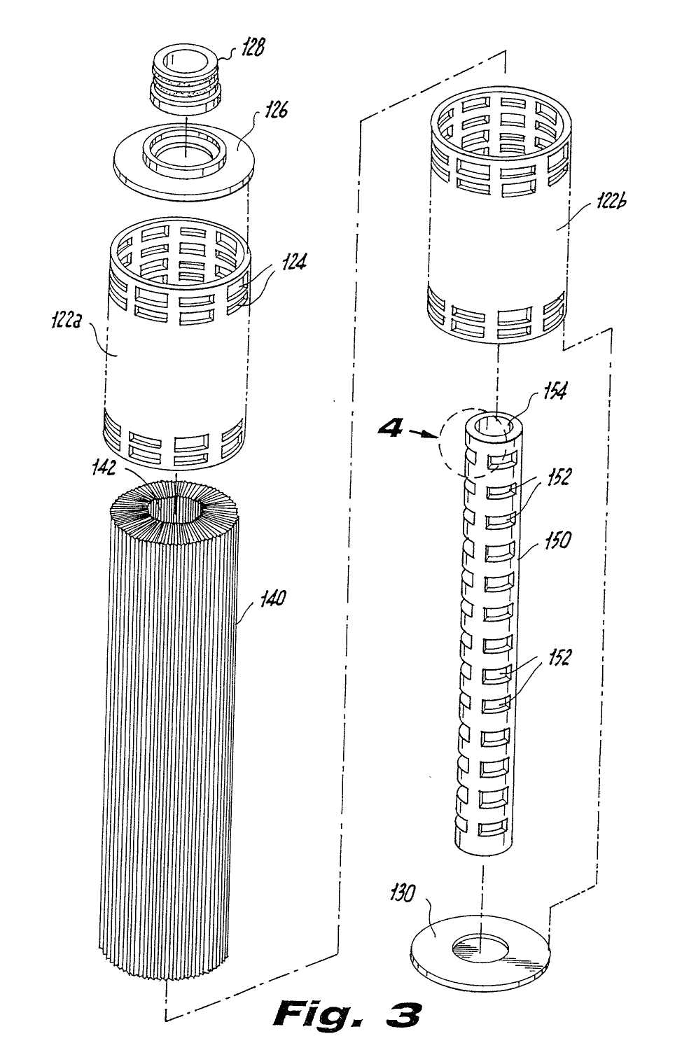

An elongated perforated cylindrical core 150 is positioned within cylindrical element 142 of filter element 140. As noted above, core 150 is chemically or physically bonded or otherwise fixedly joined to end caps 126, 130. Perforations 152 are formed in core 150 to permit passage of filtered fluid to the cylindrical interior passage 154 defined within core 150. Of note, a variety of advantageous geometries are contemplated for cylindrical core 150. Indeed, with reference to FIGS. 4-6, several alternative core geometries are depicted, namely exemplary cores 150, 150a and 150b.

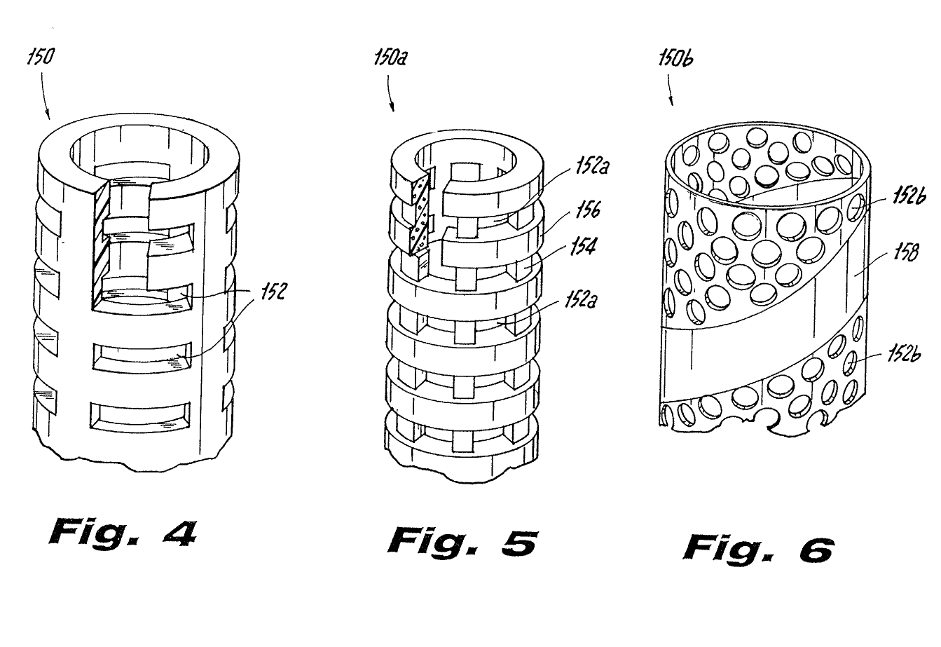

Core 150 shown in FIGS. 2-4 includes spaced, substantially rectangular perforations 152 formed in the body of core 150. The wall thickness of core 150 is substantially uniform throughout. Core 150a depicted in FIG. 5 also includes a plurality of spaced, substantially rectangular perforations 152a. However, unlike core 150, alternative core 150a includes vertical members 156 of lesser thickness than circumferential members 158, thereby defining an irregular thickness for core 150a. With reference to FIG. 6, core 150b includes spaced, substantially circular perforations 152b and a spiral or helical non-perforated band 158. Core 150b is typically fabricated from stainless steel. These alternative core configurations 150, 150a, 150b are representative of advantageous alternative designs that may be employed in filter cartridge assemblies according to the present disclosure.

According to the present disclosure, cores 150, 150a, 150b are preferably fabricated from material(s) that resist swelling/expansion when exposed to strong solvent solutions, e.g., methylene chloride, benzene, heptane, toluene, tri-chloroethylene and/or xylene. Preferably, cores 150, 150a, 150b are constructed from glass filled polypropylene (e.g., 20 to 50% fiberglass-reinforced polypropylene, and preferably 40% fiberglass-reinforced polypropylene). It is further envisioned that cores 150, 150a, 150b may be advantageously fabricated from a fluorinated aliphatic hydrocarbon, such as, for example, MFA, PFA, PTFE, Kynar® or Halar® products. Cores 150, 150a, 150b may also be advantageously fabricated from a glass filled polyolefin, e.g., a glass filled high density polyethylene, a glass filled polypropylene, and/or a glass filled high molecular weight polyethylene. Cores 150, 150a, 150b may also be fabricated from a polymer that includes a functional filler in an amount effective to limit the axial expansion the core to an acceptable level when exposed to a strong solvent. Exemplary functional fillers include calcium carbonate, talc carbon fiber and/or talc. The addition of an effective amount of a functional filler advantageously transforms a polymer that would exhibit unacceptable axial expansion characteristics when exposed to a strong solvent into a polymeric material exhibiting advantageous axial expansion characteristics when used to fabricate a core as part of a filter cartridge assembly.

The functionally filled polymeric materials exhibit limited expansion and/or structural deformation when exposed to strong solvents, e.g., methylene chloride, benzene, heptane, toluene, tri-chloroethylene and/or xylene. Preferred functional fillers and polymers for use in fabricating the disclosed cores according to the present disclosure are generally available from commercial sources and may be fabricated into the desired core geometry using conventional polymer processing equipment and techniques.

According to preferred embodiments of the present disclosure, the level of axial expansion exhibited by cores fabricated from the advantageous polymeric materials disclosed herein is generally less than 1.5% when exposed to a strong solvent, e.g., methylene chloride, benzene, heptane, toluene, tri-chloroethylene and/or xylene, for a period of seven days. Fabrication of cores 150, 150a, 150b from a material that resists swelling/expansion when exposed to a strong solvent solution further enhances and/or ensures optimal filter cartridge performance according to the present disclosure.

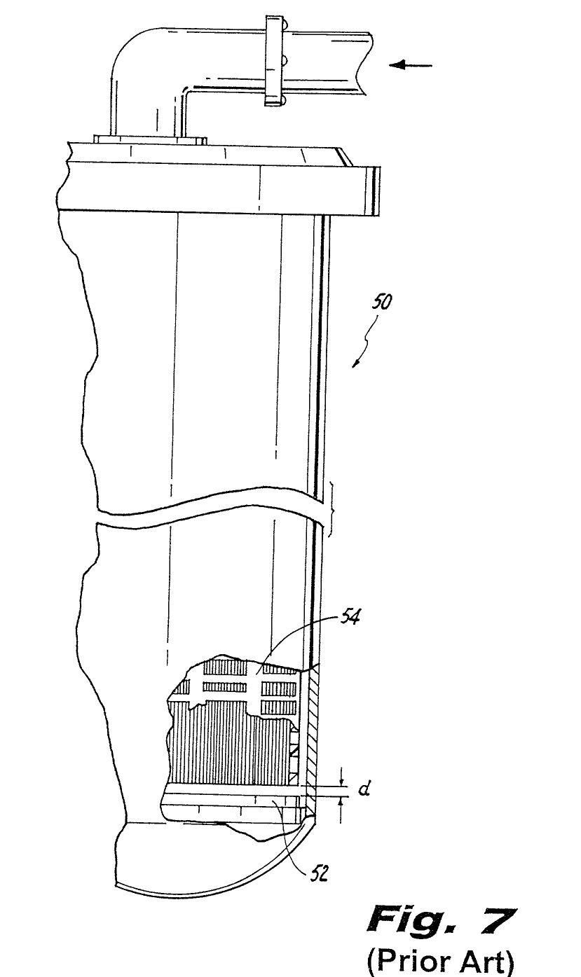

Filter cartridge assemblies according to the present disclosure are particularly adapted and/or suited for use in systems wherein strong solvent solutions are to be processed, e.g., systems that include methylene chloride, benzene, heptane, toluene, tri-chloroethylene and/or xylene. It has been found that prior art filter cartridge assemblies used in processing such strong solvent solutions have an undesirable tendency to swell/expand during use. As shown in the depiction of prior art filter cartridge assembly 50 in FIG. 7, such swelling/expansion can cause end cap(s) 52 to become dislodged or otherwise separated from the core (not visible) and/or cage 54 (e.g., by a distance “d”), thereby interfering with effective operation of prior art filter cartridge assemblies 50.

Turning to FIG. 8, exemplary filter cartridge assembly 120 is depicted prior to use in processing/filtering a strong solvent solution, e.g., a methylene chloride solution. For clarity, cartridge housing 102 and associated piping aspects of the processing/filtering system are omitted from FIG. 8. Prior to use in filtering a methylene chloride solution, cage portions 120a, 120b are initially spaced by a distance “S”, i.e., discontinuous region 120c is defined by a distance “S”. The spacing “S” of cage portions 120a, 120b does not affect the structural integrity of filter cartridge assembly 120 because the internal core and end cap components provide the necessary structural rigidity to cartridge assembly 120.

Optimal dimensions for spacing “S” within discontinuous region 122c are generally based on parameters associated with the applicable filtering system, e.g., the overall axial dimension of the filter cartridge assembly, the solvent solution to be treated, the temperature and time of system exposure, and the like. For a filter cartridge assembly having an axial dimension of thirty inches that is intended to be used to treat a methylene chloride solution at an elevated temperature for an extended period, it has been found that a spacing “S” of about one inch offers significant processing advantages according to the present disclosure. Thus, a typical spacing “S” according to the present disclosure constitutes a distance of about 2.5% to about 4% of the filter cartridge length, and preferably about 3% to about 3.5% of such cartridge length. Different spacings are contemplated and may be employed to achieve advantageous results according to the present disclosure, provided such spacing accommodates levels/degrees of swelling/expansion to be experienced by individual cage components within the applicable solvent system. In addition, it is contemplated that a plurality of discontinuous regions may be provided by separating the cage into three or more spaced portions.

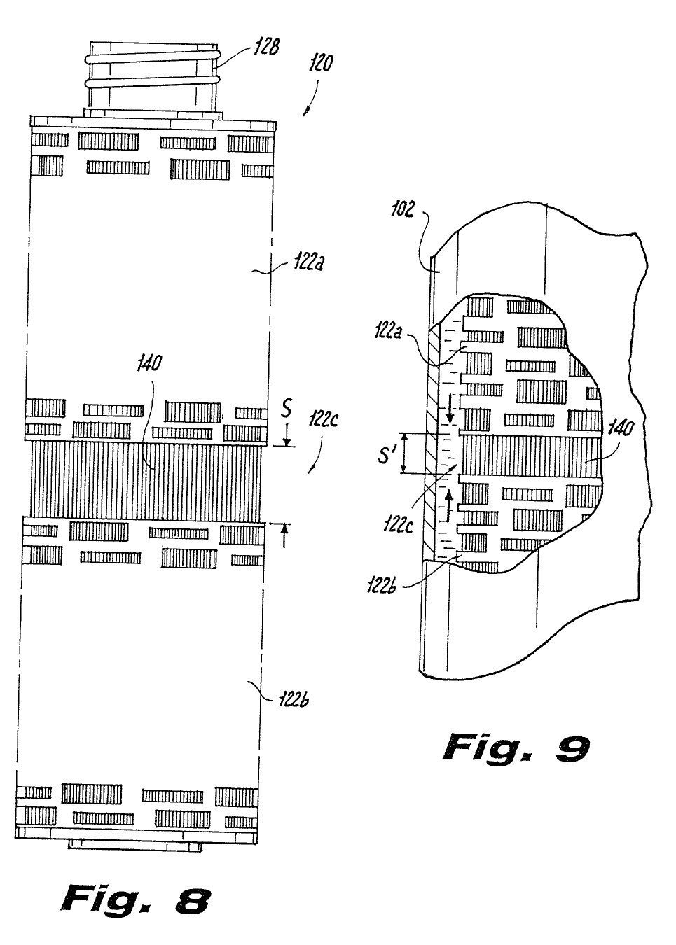

Turning to FIG. 9, filter cartridge assembly 120 is shown after a period of time in which a methylene chloride solution has been filtered within filter cartridge assembly 100. As a result of such solvent exposure, cage portions 122a and 122b have each swollen/expanded into or toward the discontinuous region 122c, thereby reducing the spacing therebetween to a distance S′. In preferred embodiments of the present disclosure, the distance S′ never equals zero, i.e., despite swelling/expansion of cage portions 122a, 122b, discontinuous region 122c nonetheless provides an area of spacing between cage portions 122a, 122b. Despite the spacing between cage portions 122a, 122b, core 150 ensures structural integrity of filter cartridge assembly 120.

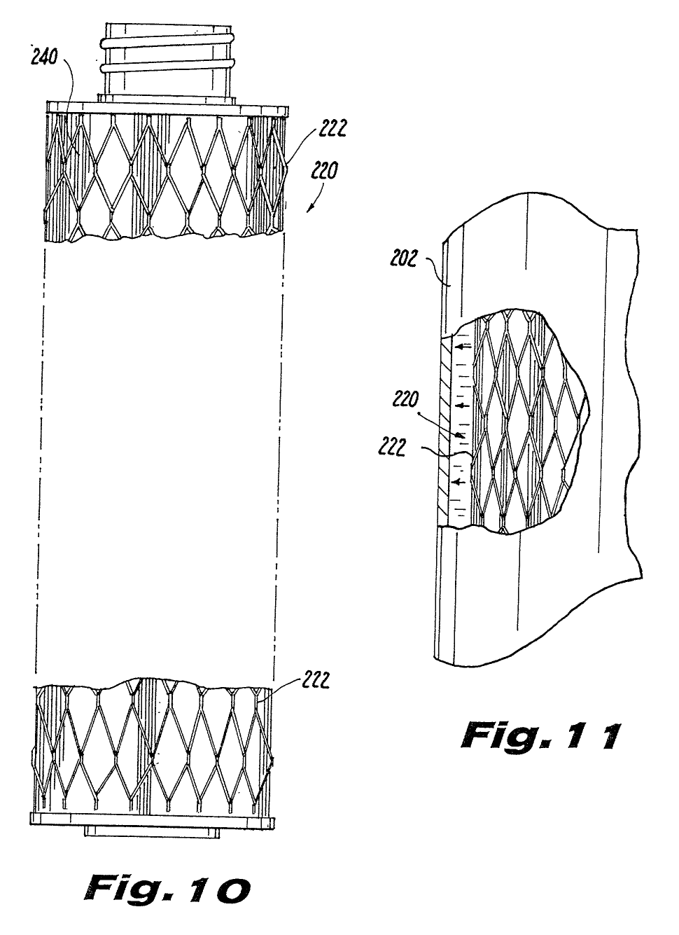

Turning to FIGS. 10 and 11, an alternative cage embodiment according to the present disclosure is shown incorporated into filter cartridge assembly 220. The majority of the components of filter cartridge assembly 220 are identical to those described with reference to filter cartridge assembly 120. Thus, a core is provided that is bonded or otherwise fixedly joined to end caps, the core being preferably fabricated from a material resistant to expansion, as described hereinabove. Filter element 240 surrounds the core and is positioned within filter housing 202. Cage 222 constitutes an expandable netting wrap that generally extends axially and defines the outer periphery of filter cartridge assembly 220.

As shown in FIG. 11, the expandable netting of cage 222 facilitates processing of a strong solvent solution within filter cartridge housing 202, without risk that swelling/expansion of cage 222 will affect undesirable dislodgement or separation of the end caps from the core. The elasticity of such expandable netting provides significant flexibility in the operation of filter cartridge assembly 220, because cage 222 exhibits minimal axial elongation and, due to the nature of the netting design, exerts minimal axial force against the spaced end caps, as shown in FIG. 11.

Additional cage designs are contemplated for use in filter cartridge assemblies according to the present disclosure, i.e., cage designs that will function advantageously in filter cartridge assemblies that are being used to process/filter strong solvent solutions. For example, it is contemplated that a cage may include three distinct regions: top and bottom regions that are each fabricated from conventional polypropylene material and include a plurality of conventional perforations (e.g., rectangular perforations), and interspersed between the top and bottom regions is an intermediate region featuring angled struts connecting the top and bottom regions. The struts may be fabricated from polypropylene, but in response to swelling/expansion of the top and bottom regions, will redirect the axial force associated therewith at least in part to a radial force along such angled struts.

Alternatively, the cage and/or struts may be fabricated from functionally filled polymeric materials of the type described herein above with reference to the core, e.g., a functionally filled polyolefin such as a filled high density polyethylene, a filled high density polypropylene, or a filled molecular weight polypropylene. According to preferred embodiments of the present disclosure, the polyolefin may be functionally filled with a filler selected from glass fibers, carbon fibers, calcium carbonate, talc and/or mica. Additional mineral-based fillers may be advantageously utilized, as will be apparent to persons skilled in the art based on the teachings herein.

Thus, according to the present disclosure, expansion resistant filter cartridge assemblies are provided that facilitate filtering of strong solvent solutions. The advantageous filter cartridge assemblies have application in a variety of industrial applications that involve filtering strong solvent solutions. The disclosed filter cartridge assemblies provide an enhanced, cost effective, efficacious filtering system for use in such applications. Further aspects, features and advantages associated with the disclosed filter cartridge assemblies will be apparent from the examples which follow:

### EXAMPLE 1

Three (3), 10 inch Sumitomo PTFE filter cartridges were separately static soaked in methylene chloride. Each cartridge was assembled with a core made a different material, stainless steel, polypropylene, and 40% fiberglass reinforced polypropylene. All of the cartridges were assembled with polypropylene end caps and outer cage. The outer cage of two of the cartridges were split parallel to the length of the cartridge and an approximate 3 inch middle section was removed. The soak tests were performed at ambient temperature, for a period of twelve (12) days. Compatibility of the cartridge's plastic parts with methylene chloride was evaluated by measuring physical dimensions of length and outside diameter. Three individual length and outside diameter measurements were recorded and averaged. The physical dimensions were measured before and after 1, 2, 4, 7, and 12 day(s) of exposure to the methylene chloride.

Materials

One (1) 10″ Sumitomo PTFE filter cartridge with all polypropylene hardware.

One (1), 10″ Sumitomo PTFE filter cartridge with stainless steel core and polypropylene end caps and split outer cage.

One (1), 10″ Sumitomo PTFE filter cartridge with 40% fiberglass reinforced polypropylene core and polypropylene and caps and split outer cage.

Methylene Chloride (Technical Grade).

TABLE 1
(Control)
Average Percent Change Of Outside Diameter (OD)
And Length Measurements Sumitomo PTFE Filter Cartridge
With All Polypropylene Hardware After Exposure To Methylene Chloride

| | | | | Avg. | |
|---|---|---|---|---|---|
| | | Avg. OD Of | Avg. OD Of | Cartridge | Avg. OD |
| | | Top End | Bottom End | Length | Of Outer |
| Length Of | | Cap Percent | Cap (O-ring) | Percent | Cage Percent |
| Exposure | | Change | Percent Change | Change | Change |
| 1 | Day | +0.89 | +0.79 | +1.61 | +2.58 |
| 2 | Days | +1.56 | +1.45 | +2.97 | +2.95 |
| 4 | Days | +2.32 | +2.36 | +3.07 | +3.15 |
| 7 | Days | +2.66 | +2.63 | +3.10 | +3.45 |
| 12 | Days | +2.80 | +2.80 | +3.15 | +3.25 |

Table 1 indicates that after the filter cartridge with all polypropylene hardware was exposed to the methylene chloride for 12 days, average percent increases in end cap outside diameters, cartridge length, and outer cage outside diameter of 2.80%, 2.80%, 3.15%, and 3.25% respectively, were measured.

The average percent change in end cap outside diameter stabilized after approximately 4 days of exposure to the methylene chloride. The average percent change in cartridge length (end cap to end cap) and outer cage outside diameter stabilized after approximately 2 days of exposure.

TABLE 2
Average Percent Change Of Outside Diameter (OD)
And Length Measurements Sumitomo PTFE Filter Cartridge
With 40% Fiberglass Reinforced Core, Polypropylene End Caps,
And Split Cage After Exposure To Methylene Chloride

| | | | | Avg. | |
|---|---|---|---|---|---|
| | | Avg. OD Of | Avg. OD Of | Cartridge | Avg. OD |
| | | Top End | Bottom End | Length | Of Outer |
| Length Of | | Cap Percent | Cap (O-ring) | Percent | Cage Percent |
| Exposure | | Change | Percent Change | Change | Change |
| 1 | Day | +0.93 | +1.28 | +0.93 | +2.77 |
| 2 | Days | +1.67 | +2.33 | +1.21 | +2.87 |
| 4 | Days | +2.47 | +2.77 | +1.18 | +3.11 |
| 7 | Days | +2.71 | +2.88 | +1.17 | +3.14 |
| 12 | Days | +2.84 | +2.74 | +1.23 | +3.17 |

As indicated in Table 2, after the filter cartridge with 40% fiberglass reinforced polypropylene core was exposed to the methylene chloride for 12 days, average percent increases in end cap outside diameters, cartridge length, and outer cage outside diameter of 2.84%, 2.74%, 1.23%, and 3.17% respectively, were measured.

The average percent change in end cap outside diameter stabilized after approximately 4 days of exposure to the methylene chloride. The average percent change in cartridge length and outer cage outside diameter stabilized after approximately 2 days of exposure.

### EXAMPLE 2

A 10″ PTFE media filter cartridge with a 40% fiberglass reinforced polypropylene filter core, polypropylene end caps and mesh outer cage was static soaked, at ambient temperature, in methylene chloride for a period of seven (7) days. Compatibility of the filter cartridge's plastic parts was evaluated by measuring physical dimensions of length and outside diameter. Three individual measurements per physical dimension were recorded and averaged before and after the 7 day soak.

TABLE
Average End Cap Outside Diameter And Cartridge Length Percent Change
40% Reinforced Fiberglass Polypropylene Filter Core,
Polypropylene End Caps And Mesh Outer Cage
With Methylene Chloride

| End Cap # 1 | End Cap # 2 | Cartridge Length |
|---|---|---|
| Outside Diameter | Outside Diameter | Average |
| Average Percent Change | Average Percent Change | Percent Change |
| 2.56% Increase | 2.53% Increase | 1.34% Increase |

As indicated in the Table, after 7 days of exposure to methylene chloride, average increases in the outside diameter of the end caps and cartridge length of 2.55% and 1.34% respectively, were measured. Visual observation of the filter cartridge indicated that some warping of the mesh outer cage occurred after 7 days of exposure to methylene chloride.

Although filter cartridge assemblies of the present disclosure have been described with reference to exemplary embodiments thereof, the present disclosure is not to be limited to the specifics of the disclosed embodiments, but is to be broadly understood in the context of filter cartridge assemblies for use in filtering fluid systems, particularly fluid systems that may be used to filter strong solvent solutions. The disclosed embodiments are merely illustrative, and not limitative, of the scope of the present invention, and changes, modifications and/or variations may be utilized without departing from the spirit or scope of the present invention.

1. A filter cartridge assembly comprising:
a) a cylindrical filter element defining an outer periphery, an inner periphery and opposed end surfaces;
b) a perforated cage operatively associated with the outer periphery of said cylindrical filter element;
c) a perforated core operatively associated with said inner periphery of said cylindrical filter element, said perforated core having opposed ends and a predetermined axial length; and
d) an end cap operatively associated with each of said opposed end surfaces of said filter element and bonded to each end of the core;
wherein said perforated core is fabricated from a functionally filled polymeric material that exhibits limited axial expansion when exposed to a strong solvent solution.

2. A filter cartridge assembly according to claim 1, wherein said perforated cage includes a first cage portion and a second cage portion separated by a region of axial discontinuity.

3. A filter cartridge assembly according to claim 2, wherein said region of axial discontinuity is at least about 2.5% of the length of said cylindrical filter element.

4. A filter cartridge assembly according to claim 1, wherein said perforated cage includes a first cage portion and second cage portion, and wherein said first and second cage portions are joined by a plurality of angular struts that accommodate axial expansion of said perforated cage.

5. A filter cartridge assembly according to claim 1, wherein said functionally filled polymeric material is a polyolefin that is functionally filled with a material selected from the group consisting of glass fiber and a mineral-based filler.

6. A filter cartridge assembly according to claim 1, wherein said functionally filled polymeric material is a polyolefin that is functionally filled with a filler selected from the group consisting of glass fibers, calcium carbonate, carbon fibers, talc and mica.

7. A filter cartridge assembly according to claim 1, wherein said functionally filled polymeric material exhibits less than 1.5% axial expansion when exhibited to a strong solvent solution for a period of seven days.

8. A filter cartridge assembly according to claim 7, wherein said strong solvent solution is selected from the group consisting of methylene chloride, benzene, heptane, toluene, tri-chloroethylene and xylene.

9. A filter cartridge assembly according to claim 1, wherein said filter element is a pleated membrane filter element wherein said pleats are selected from the group consisting of radial pleats, w-pleats and spiral pleats.

10. A filter cartridge assembly according to claim 9, wherein said filter element includes at least one media layer, an upstream support material and a downstream support material.

11. A filter cartridge assembly according to claim 10, wherein at least one of said media layer, said upstream support material and said downstream support material is fabricated from a fluorinated aliphatic hydrocarbon material.

12. A filter cartridge assembly comprising:
a) a cylindrical filter element defining an outer periphery, an inner periphery and opposed end surfaces;
b) an expandable netting operatively associated with the outer periphery of said cylindrical filter element;
c) a perforated core operatively associated with said inner periphery of said cylindrical filter element, said perforated core having opposed ends and a predetermined length; and
d) an end cap operatively associated with each of said opposed end surfaces of said filter element and bonded to each end of the core;
wherein said perforated core is fabricated from a functionally filled polymeric material that exhibits limited axial expansion when exposed to a strong solvent solution.

13. A filter cartridge assembly according to claim 12, wherein said functionally filled polymeric material is a polyolefin that is functionally filled with a material selected from the group consisting of glass fiber and a mineral-based filler.

14. A filter cartridge assembly according to claim 12, wherein said functionally filled polymeric material is a polyolefin that is functionally filled with a filler selected from the group consisting of glass fibers, calcium carbonate, carbon fibers, talc and mica.

15. A filter cartridge assembly according to claim 12, wherein said functionally filled polymeric material exhibits less than 1.5% axial expansion when exhibited to a strong solvent solution for a period of seven days.

16. A filter cartridge assembly according to claim 15, wherein said strong solvent solution is selected from the group consisting of methylene chloride, benzene, heptane, toluene, tri-chloroethylene and xylene.

17. A filter cartridge assembly according to claim 12, wherein said filter element is a pleated membrane filter element wherein said pleats are selected from the group consisting of radial pleats, w-pleats and spiral pleats.

18. A filter cartridge assembly according to claim 17, wherein said filter element includes at least one media layer, an upstream support material and a downstream support material.

19. A filter cartridge assembly according to claim 18, wherein at least one of said media layer, said upstream support material and said downstream support material is fabricated from a fluorinated aliphatic hydrocarbon material.
